(19) United States
(12) Patent Application Publication
(10) Pub. No.: US 2006/0091886 A1
(43) Pub. Date: May 4, 2006

(54) Low esr switch for nuclear resonance measurements

(76) Inventors: John Harold Flexman, Western Australia (AU); Christopher Norman Aitken, Western Australia (AU)

Correspondence Address: PILLSBURY WINTHROP SHAW PITTMAN LLP, 1650 TYSONS BOULEVARD, MCLEAN, VA, 22102, US

(21) Appl. No.: 10/519,143

(22) PCT Filed: Jun. 25, 2003
(86) PCT No.: PCT/AU03/00801

§ 371 Date: Sep. 22, 2005

(30) Foreign Application Priority Data
Jun. 25, 2002 (AU) PS3191

(51) Int. Cl. G01V 3/00

(52) U.S. Cl. 324/322

(57) ABSTRACT

A low equivalent series resistance (ESR) switch for selectively adding to a coil-capacitor circuit of a nuclear or electron resonance system. The switch comprises a pair of physically and electrically contacting members having mutually large contact surface areas. The members are movable between a quiescent position where the contact surface areas are separated by a small distance and an active position where the contact surface areas are brought into physical and electrical contact to connect into the coil-capacitor circuit.

### FIELD OF THE INVENTION

This invention relates to the detection of particular substances using nuclear and electronic resonance detection technology. It has particular application, with respect to nuclear quadrupole resonance (NQR), but some aspects of it also have application with respect to nuclear magnetic resonance (NMR), magnetic resonance imaging (MRI) and electron spin resonance technologies.

More specifically the invention relates to switching between substantially different frequencies, whilst maintaining a low Equivalent Series Resistance (ESR) resistance across a resonant coil for the purposes of nuclear resonance detection.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to is or was part of the common general knowledge as at the priority date of the application.

In the fields of Magnetic Resonance Imaging (MRI), Nuclear Magnetic Resonance (NMR), and Nuclear Quadrupole Resonance (NQR), resonant coils are used in systems to detect signals from a substance or item under examination. The coils are connected to capacitors to resonate the particular system at an RF frequency. As can be seen from equation 1 below, by changing the capacitance and not changing the coil dimensions (i.e. upon which the inductance L is dependent), the frequency changes:

$${ω}^{2} = \frac{1}{L . C} \qquad ( 1 )$$

In the field of NQR, in particular, there is often the need to try and detect different substances at very different frequencies. For instance, an NQR explosive detector may be required to detect RDX at 5.2 MHz and then be switched to PETN, which has a resonant frequency at 0.89 MHz. As is evident from equation 1, to move the resonant frequency of the coil from 5.2 MHz to 0.89 MHz requires a large number of capacitors to be switched into the circuit, a typical example of which is shown at FIG. 1 of the drawings. As shown, capacitors 7 and 8 are connected in parallel with a coil 9 to form a resonant circuit, whereby the capacitor 7 is switched in or out of the circuit by means of the switch 5. To perform this switching operation an operator skilled in the art could use a relay or semiconductor device.

The strength of the signal derived from an NQR system is partially dependent upon the Q (quality factor) of the coil system. According to equation 2 the Q of a coil is dependent upon the resistance (R) of the circuit.

$$Q = \frac{ω L}{R} \qquad ( 2 )$$

Hence the ESR of the switching device will affect the circuit as it will be a part of it when switching between frequencies is required. The switch ideally needs to have zero ESR, however this is unrealistic. An inherent problem with mechanical relays is that they have a high ESR and are prone to ‘catching’ after many operations. Semiconductor devices while being more reliable than relays, also have a high ESR.

### DISCLOSURE OF THE INVENTION

It is an object of the present invention to lower the resistance of a coil-capacitor circuit in a nuclear or electron resonance system, such as involving NQR, NMR, electron spin resonance or MRI to increase the Q of the system and thus increase the sensitivity of the system.

The present invention seeks to solve the problem of lowering the resistance of a coil-capacitor circuit by introducing a low equivalent series resistance (ESR) switch. The introduction of this switch lowers the resistance of the coil-capacitor circuit and results in a higher Q than would otherwise be achieved if relays or semiconductor devices were used.

In accordance with a first aspect of the present invention there is provided in a coil-capacitor circuit of a nuclear or electron resonance system, a low equivalent series resonance (ESR) switch selectively added thereto. This switch comprises a pair of physically and electrically contacting members having mutually large contact surface areas, the members being movable between a quiescent position where the contact surface areas are separated by a small distance, and an active position where the contact surface areas are brought into physical and electrical contact to connect into the coil-capacitor circuit.

In accordance with another aspect of the present invention, there is provided a low equivalent series resistance (ESR) switch for selectively adding to a coil-capacitor circuit of a nuclear or electron resonance system, the switch comprising a pair of physically and electrically contacting members having mutually large contact surface areas, said members being movable between a quiescent position where the contact surface areas are separated by a small distance and an active position where the contact surface areas are brought into physical and electrical contact to connect into the coil-capacitor circuit.

Preferably, the contacting members are moved between the quiescent and active positions by the action of actuating means such as a pneumatic air piston system, motor or solenoid.

Preferably, the contacting members comprise a pair of parallel bars and the ESR switch includes a plurality of insulated guide rods to guide the parallel bars in and between the quiescent and active positions.

Preferably, the contacting members contacts are made from copper.

Preferably, the contacting members contacts are made or coated with gold.

Preferably, the contacting members contacts are made or coated with rhodium.

Preferably, the contacting members contacts are made or coated with silver.

Preferably, the contacting members contacts are made or coated with mercury and are contained within a vessel which prevents the escape of the mercury.

Preferably, the entire switch is contained within a vacuum vessel.

Preferably, the switch comprises an oval cross-section shaped rod lying between two concave parallel bars. The oval cross section rod may be rotated to connect or disconnect with concave parallel bars.

Preferably, the switch comprises an elongated multi-pole switch, where the rotation of the switch allows lugs to touch and thus connect the circuit.

In accordance with a further aspect of the invention, there is provided a method for selectively adding a low equivalent series resistance into a coil-capacitor circuit of a nuclear or electron resonance system, the method comprising:

moving two large contact surface areas between a quiescent position where the contact surface areas are separated by a small distance and an active position where the contact surface areas are brought into physical and electrical contact;

wherein a low equivalent series resistance is disconnected from the coil-capacitor circuit when the contact surface areas are in the quiescent position and is connected into the coil-capacitor circuit when the contact surface areas are in the active position.

### BRIEF DESCRIPTION OF THE DRAWINGS

The invention will be better understood in the light of the following description of the best mode for carrying out the invention. The description is made with reference to FIGS. 2 to 4, and several specific embodiments of the best mode. The drawings accompanying the specification are described below:

FIG. 1 shows the prior art arrangement for switching in extra capacitance into a resonant circuit.

FIG. 2 shows the first embodiment of the low ESR switch.

FIG. 3 shows the eighth embodiment of the present invention.

FIG. 4 shows the fifteenth embodiment of the present invention.

### BEST MODE(S) FOR CARRYING OUT THE INVENTION

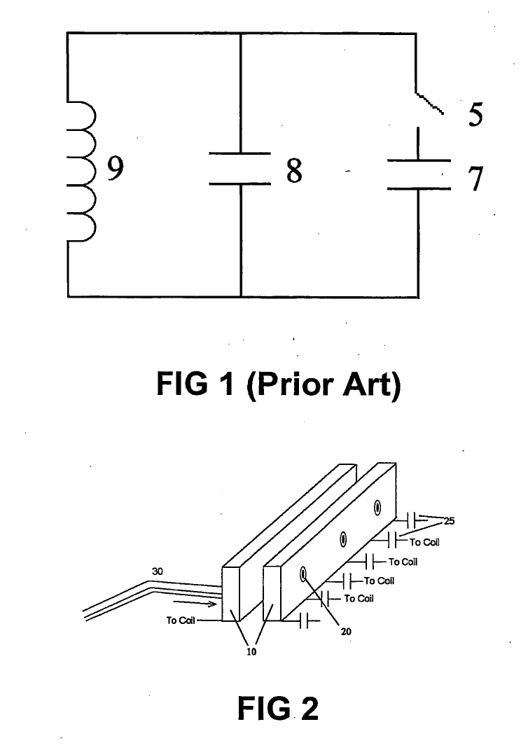

The best mode for carrying out the invention is concerned with the implementation of the coil-capacitor circuit of an NMR, MRI, electron spin resonance or NQR system. More specifically, it involves adding a low ESR switch to coil-capacitor circuits of the type shown in FIG. 1.

The low ESR switch in the best mode consists of two moveable, parallel metal bars, adapted to be disposed between a quiescent position with a small gap between the bars, or an active position where the bars are brought into physical and electrical contact with each other. The bars are particularly characterised by having a comparatively large contact surface area, when brought into the active position. An actuating means is provided with the ESR switch to either pushs the two metal bars together to make contact or to separate them. The parallel bars are of any convenient shape that provides solid electrical contact, for instance two flat bars or a triangular shaped bar impinging upon a concave triangular shape.

The first embodiment of the best mode is directed towards an ESR switch of the form shown in FIG. 2. The switch comprises two flat parallel metallic bars 10 having a mutually large contact surface area, which in their quiescent position, are separated by a small distance. An actuating means in the form of a pneumatic air piston system or a motor or solenoid (not shown in FIG. 2) drives the two bars together when contact is required. Alignment is maintained through insulated guide rods 20. In practice, this action normally occurs under the direction of a controlling computer.

The large contact surface area of the switch provides extra surface area for the current to flow over thus minimising the resistance. This switch allows the operator to increase the capacitance of the circuit without detrimentally compromising the resistance and thus the Q of the coil-capacitor system.

For example in NQR, when switching from RDX to PETN frequencies, a large insertion of capacitance into the circuit is required, in the order of nanoFarads. The switch is closed by the computer, resulting in contact between the coil and the second bank of capacitors, resulting in the frequency being changed from near 5 MHz to near 0.89 MHz.

As well as performing coarse tuning like above, smaller versions of the switch can be used to fine-tune the coil. These smaller versions replace relays and result in a lowering of the resistance of the final circuit and thus an increase in Q.

The second embodiment is the same as the first embodiment, except that parallel bars are coated with a metal, which prevents corrosion and/or prevents carbonisation of the metal surface.

In one implementation of the embodiment, the metal added is gold. The addition of gold contacts prevents corrosion of the metal surface by oxidation and carbonisation. As the gold is soft and malleable the contacts mold together thus providing a better contact.

In an alternative implementation of the embodiment, the parallel bars are coated with rhodium. The addition of rhodium contacts prevents corrosion and carbonisation of the metal surface. Rhodium is also extremely hard and will not deform with time allowing quality contacts over the lifetime of the switch.

In another implementation of the embodiment, the parallel bars are coated with liquid mercury. The addition of mercury contacts prevents corrosions and carbonisation of the metal surface. The addition of mercury would require a containment vessel to prevent the loss of mercury into the environment due to its hazardous health effects.

In a further alternative implementation of the embodiment, the parallel bars are coated with silver. The addition of silver prevents corrosion of the metal surface underneath.

The third embodiment is the same as the first, except that the entire switch is isolated inside a vacuum. The use of a vacuum chamber around the metal bars prevents the oxidation of these bars allowing an increase in the useable lifetime of the switch.

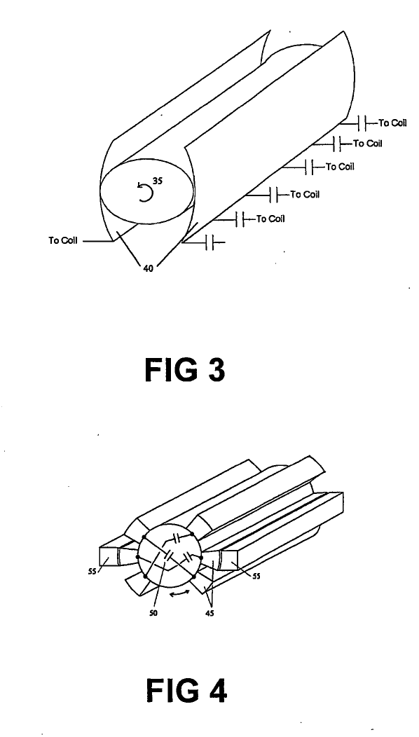

The fourth embodiment is similar to the preceding embodiments, except that it involves adding a low ESR switch of the type shown in FIG. 3 to the coil-capacitor circuit of an NQR, NMR, electron spin resonance or MRI system.

As shown, the low ESR switch consists of a rotatable oval cross-section shaped metallic bar 35 lying between two concave plates or bars 40, having a mutually large contact surface area. An actuating means in the form of a pneumatic air piston system or a motor or solenoid turns the oval cross-section shaped bar to contact the plates 40 when contact is required. This action occurs under direction from a controlling computer. The large contact surface area of the switch provides extra surface area for the current to flow over thus minimising the resistance. This switch allows an increase in the capacitance of the circuit without detrimentally compromising the resistance and thus the Q of the coil-capacitor system.

The fifth embodiment is the same as the eighth embodiment, except that the oval shaped cross section bars are coated with a metal to prevent corrosion and carbonisation of the metal surface.

In one implementation of the fifth embodiment, the oval shaped cross section bars are coated with gold.

In an alternative implementation of the fifth embodiment, the oval cross-section shaped bars are coated with rhodium.

In another implementation of the fifth embodiment, the oval cross-section shaped bars are coated with silver.

In a further alternative implementation of the fifth embodiment, the oval cross-section shaped bars are coated with liquid mercury. The liquid mercury is sealed within a vessel.

The sixth embodiment is substantially the same as the fourth or fifth embodiments, except that the switch is sealed within a vacuum chamber to prevent corrosion of the switch.

The seventh embodiment is similar to the preceding embodiments except that it involves adding a low ESR switch of the type shown in FIG. 4 to the coil-capacitor circuit of a NQR, NMR, electron spin resonance or MRI system.

As shown, the low ESR switch consists of a rotatable multi-pole switch having a plurality of radially disposed and transversely spaced metallic lugs 45 providing a sliding connection with a pair of radial and externally mounted concave contacts 55, the lugs 45 and the contacts 55 mutually having a large contact surface area. An actuating means in the form of a pneumatic air piston system or a motor or solenoid (not shown) turns the multi-pole switch when contact is required. In practice, this action occurs under direction of a controlling computer.

The large contact surface area of the switch provides extra surface area for the current to flow over thus minimising the resistance. This switch allows an increase in the capacitance of the circuit without detrimentally compromising the resistance and thus Q of the coil-capacitor system.

Capacitors 50 that are to be switched into the circuit are located within the barrel section of the switch. Each capacitor system is electrically isolated from each other such that when the switch is turned, only the capacitors connected to the lugs 45 that make contact with the concave contacts 55 conduct electricity.

The eighth embodiment is the same as the seventh embodiment, except that the metallic lugs of the multi-pole switch are coated with a metal to prevent corrosion and carbonisation of metal surface of the switch.

In one implementation of the eighth embodiment, the metallic lugs of the multi-pole switch are coated with gold.

In alternative implementation of the eighth embodiment, the metallic lugs of the multi-pole switch are coated with rhodium.

In another implementation of the eighth embodiment, the metallic lugs of the multi-pole switch are coated with silver.

In a further alternative implementation of the eighth embodiment, the metallic lugs of the multi-pole switch are coated with mercury. The mercury is contained within a sealed vessel.

The ninth embodiment is substantially the same as the seventh or eighth embodiment, except that the multi-pole switch is isolated within a vacuum to prevent corrosion.

It should be appreciated that the scope of the present invention is not limited to the specific embodiments described herein and that changes and modifications in accordance with common knowledge in the art of the invention may be made that still fall within the scope of the invention.

1. In a coil-capacitor circuit of a nuclear or electron resonance system, a low equivalent series resistant switch selectively added thereto, the switch comprising a pair of physically and electrically contacting members having mutually large contact surface areas, said members being movable between a quiescent position where the contact surface areas are separated by a small distance and an active position where the contact surface areas are brought into physical and electrical contact to connect into the coil-capacitor circuit.

2. A low equivalent series resistance (ESR) switch for selectively adding to a coil-capacitor circuit of a nuclear or electron resonance system, the switch comprising a pair of physically and electrically contacting members having mutually large contact surface areas, said members being movable between a quiescent position where the contact surface areas are separated by a small distance and an active position where the contact surface areas are brought into physical and electrical contact to connect into the coil-capacitor circuit.

3. A low ESR switch as claimed in claim 1, including actuating means to move said contacting members between said quiescent position and said active position.

4. A low ESR switch as claimed in claim 1, wherein said contacting members comprise a pair of parallel bars and said ESR switch includes a plurality of insulated guide rods to guide said parallel bars in and between said quiescent position and said active position.

5. A low ESR switch as claimed in claim 1, wherein said contacting members comprise an oval cross-section shaped rod disposed between two concave parallel bars, said oval cross-section shaped rod being rotatable to said active position to physically and electrically connect with said concave parallel bars and further rotatable to said quiescent position to physically and electrically disconnect from said concave parallel bars.

6. A low ESR switch as claimed in claim 1, wherein said contacting members comprise an elongated multi-pole switch having a pair of radially disposed and transversely spaced lugs and a pair of radial, externally mounted concave contacts, the lugs being rotatable relative to the contacts, whereby rotation of the switch to different angular positions allows different pairs of lugs to make physical and electrical contact with said contacts in discrete active positions, and also to disconnect the physical and electrical contact between said lugs and said contacts in discrete quiescent positions.

7. A low ESR switch as claimed in claim 1, wherein said contacting members are coated with a metal to prevent corrosion and carbonisation of the surface thereof.

8. A low ESR switch as claimed in claim 1, wherein said contacting members are made or coated with copper.

9. A low ESR switch as claimed in claim 1, wherein said contacting members are made or coated with gold.

10. A low ESR switch as claimed in claim 1, wherein said contacting members are made or coated with rhodium.

11. A low ESR switch as claimed in claim 1, wherein said contacting members are made or coated with silver.

12. A low ESR switch as claimed in claim 1, wherein said contacting members are made or coated with mercury and are contained within a vessel which prevents the escape of the mercury.

13. A low ESR switch as claimed in claim 1, wherein the entire switch is contained within a vacuum vessel.

14. A method for selectively adding a low equivalent series resistance into a coil-capacitor circuit of a nuclear or electron resonance system, the method comprising:
moving two large contact surface areas between a quiescent position where the contact surface areas are separated by a small distance and an active position where the contact surface areas are brought into physical and electrical contact;
wherein a low equivalent series resistance is disconnected from the coil-capacitor circuit when the contact surface areas are in the quiescent position and is connected into the coil-capacitor circuit when the contact surface areas are in the active position.

15. (canceled)

16. (canceled)

17. (canceled)
